(19) United States
(12) Patent Application Publication
(10) Pub. No.: US 2004/0088648 A1
(43) Pub. Date: May 6, 2004

(54) Method for classifying information in portable data processors and portable data processor

(76) Inventors: Kalle Kangas, Oulu (FI); Juha Lehtomaki, Oulu (FI); Jari Kokkonen, Oulu (FI)

Correspondence Address: Crawford Maunu PLLC, Suite 390, 1270 Northland Drive, St. Paul, MN, 55120, US

(21) Appl. No.: 10/603,359

(22) Filed: Jun. 25, 2003

(30) Foreign Application Priority Data
Jun. 27, 2002 (FI) 20021261

(51) Int. Cl. G06F 15/00

(52) U.S. Cl. 715/500

(57) ABSTRACT

The invention relates to a method for classifying information in a portable data processor, and a portable data processor. The method comprises: processing information based on commands obtained from a user interface in the portable data processor; associating information multi-dimensionally into at least two different categories according to information type and at least one other criterion; presenting the associations in the user interface and carrying out processing related to the associations based on the commands obtained from the user interface; and storing the associations for subsequent use.

### FIELD

The invention relates to a method for classifying information in a portable data processor and to a portable data processor.

### BACKGROUND

The most basic form for classifying information in a data processor is carried out manually. For example, the user stores files, e-mail messages and web site links in a specific database, file structure etc. of a program in each information processing program. Such classification of information is one-dimensional and program-specific. Particularly in portable data processors, in which the user interface is generally more concise than for instance in personal computers, a need arises to improve the classification of information in order to alleviate the subsequent use thereof. Also the processing capacity that is lower in portable data processors than in personal computers and the limitations regarding power consumption set specific requirements to the efficiency and user-friendliness of portable data processor software.

Current e-mail programs include automatic filters that allow incoming e-mail messages to be automatically directed into a folder without requiring the user to take any real-time measures. The user must have set parameters for the filtering in advance. This may create problems, since the user does not know in advance what kind of information can be sent to him/her. Furthermore, the classification is one-dimensional, although in reality the information characteristically belongs to various categories. The subsequent retrieval of the information classified in such a manner is difficult; generally key word searches are employed that provide several irrelevant results. Keyword retrieval is also a fairly cumbersome procedure, as the search is carried out from a particular level in the directory tree, and the search is based on a few fixed steady fields (such as dates) and word retrievals.

### BRIEF DESCRIPTION

It is an object of the invention to provide an improved method for classifying information in a portable data processor and an improved portable data processor.

According to an aspect of the invention, there is provided a method for classifying information in a portable data processor comprising: processing information based on commands obtained from a user interface in the portable data processor; associating information multi-dimensionally into at least two different categories according to information type and at least one other criterion; presenting the associations in the user interface and carrying out processing related to the associations based on the commands obtained from the user interface; and storing the associations for subsequent use.

According to another aspect of the invention, there is provided a portable data processor comprising a processing unit for processing information, a user interface connected to the processing unit for presenting the information to a user of the portable data processor and for providing commands in order to process information, and a memory connected to the processing unit for storing information, and the processing unit is configured to associate information multi-dimensionally into at least two different categories according to information type and at least one other criterion, present the associations in the user interface and carry out the processing related to the associations based on the commands obtained from the user interface, and store the associations in the memory for subsequent use.

The invention is based on the idea that classification is carried out when the user is processing information using a user interface, whereby the user also controls how the classification is carried out by means of the commands provided from the user interface. What is in fact concerned is a semi-automatic classification. In addition, the classification is multi-dimensional and corresponds better than a one-dimensional classification with the inherent properties of the information.

The method and apparatus of the invention provide several advantages. The multi-dimensional properties of the classification enable to subsequently use the results thereof more efficiently. Already during the classification the user may affect the results of the classification, whereby the subsequent usability thereof improves. The nature of the information is not relevant in the solution, and therefore the portable data processor comprises in an ideal case only one classification user interface, which functions in the same way in different programs, such as a web browser, file management and an e-mail program. It is easier for the user to learn the operation logic of one classification program. Furthermore, very different kind of information associated with the same concepts or matters, can efficiently be classified to the same category or categories.

### LIST OF DRAWINGS

In the following, the invention is explained in greater detail by means of the preferred embodiments with reference to the accompanying drawings, in which

FIG. 1 is a simplified block diagram showing an example structure of a portable data processor,

FIG. 2 shows an e-mail message, and

FIG. 3 is a flow chart illustrating a method for classifying information in a portable data processor.

### DESCRIPTION OF EMBODIMENTS

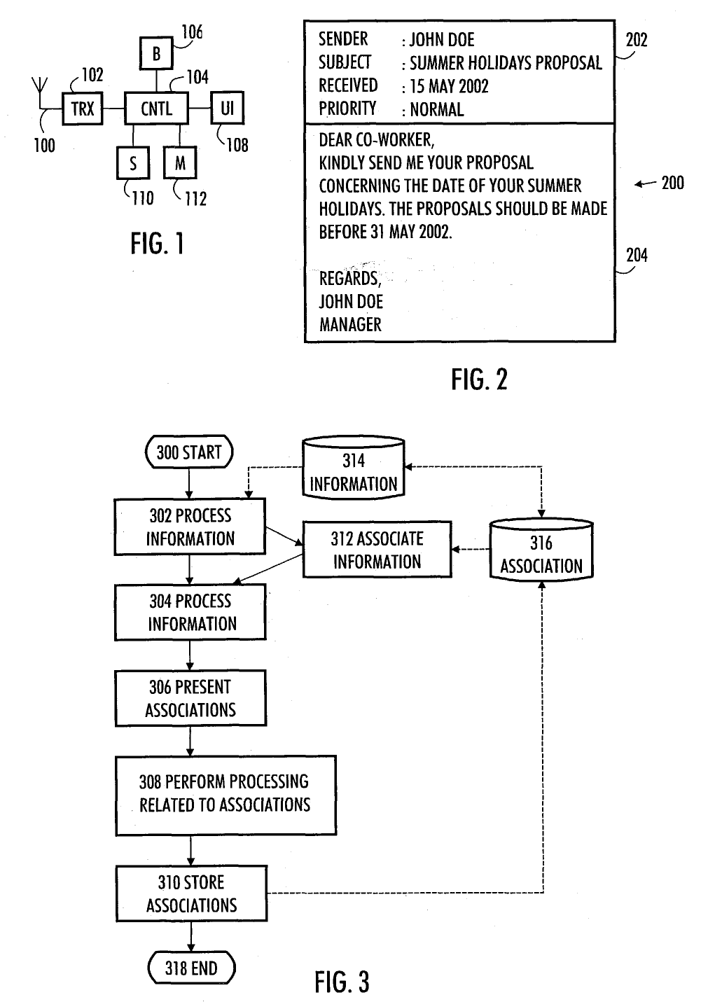

With reference to FIG. 1, an example of the structure of a portable data processor is described. The apparatus may be a portable device associated with Ubiquitous Computing, such as a subscriber terminal, of a radio system, such as a mobile phone or a PDA device (Personal Digital Assistant) or another portable data processor. Different roles may also be combined in the apparatus, meaning that it may for instance be a combination of a subscriber terminal and a PDA device, an example of which is the Nokia® Communicator™.

In our example in FIG. 1, the data processor is a subscriber terminal in a radio system. Since a subscriber terminal is used as an example, the apparatus comprises an antenna 100 and a radio transceiver 102. The radio transceiver 102 is for example a prior art mobile transceiver that operates for instance in the GSM (Global System for Mobile Communications), GPRS (General Packet Radio Service) or UMTS (Universal Mobile Telecommunications System) network.

In addition, the apparatus comprises a processing unit 104 that controls and monitors the operation of the apparatus and the different parts thereof. The processing unit 104 also includes application programs of the apparatus, for example for processing a radio signal, for processing information and for managing a user interface. At present, the processing unit 104 is implemented in general as a processor including software, but different equipment implementations are also possible, such as a circuit composed of separate logic components or one or more application-specific integrated circuits (ASIC). The number of processors may if required exceed one. Also a hybrid of these different implementations is possible. A person skilled in the art observes when selecting the implementation for instance the requirements set for the size and power consumption of the apparatus, the required processing power, the manufacturing costs and the production volume.

Furthermore, the data processor comprises a user interface 108 connected to the processing unit 104. The user interface 108 can be implemented in accordance with the prior art. The user interface may comprise for example a keyboard for controlling the data processor, feeding information and providing information processing commands and a display for showing information, and also a microphone and a loudspeaker for processing sound. A chargeable battery 106 generally operates as the power source. The apparatus also comprises a memory 112 connected to the processing unit 104 for storing information. The memory 112 can be implemented as is known in the art for implementing a non-volatile memory, for instance as memory circuits or as a small hard disc.

In order to implement the classification of information, the processing unit 104 is configured to associate information multi-dimensionally into at least two different categories according to information type, and at least one other criterion. The processing unit 104 is also configured to present the associations in the user interface 108 and to carry out the processing related to the associations based on the commands obtained from the user interface 108. The processing related to the associations can be implemented for instance in such a manner that the user is offered three possibilities through the user interface 108; to accept an association, to reject an association, to change an association. The user then performs the choice in the user interface 108 using the command provided, which is interpreted in the processing unit 104, and then the desired processing related to the association is carried out. In an embodiment, the information is a file, and the processing unit 104 is configured to carry out the presentation when storing or closing a file. In an embodiment the information is a web site and the processing unit 104 is configured to carry out the presentation when exiting the web site, or when closing a browser used for browsing, or later when the data transmission connection of the portable data processor is offline.

The processing unit 104 is configured in such a manner that it is capable of processing different types of information. In an ideal case, all information processed in the data processor can be classified using consistent processing that the processing unit 104 offers and a similar user interface 108. The information may be of the following types: a file, an e-mail message, a web site, a text message, a multi-media message, a calendar message, a task message, and another set of data presented using alphabetic and/or numeric characters, binary data (such as a sound file, an image file, a video file, an executable program file).

The criteria used in association naturally vary according to information type, and therefore listing all possible combinations becomes difficult. The criteria may for example be the following ones: title of information (the title as an entity or individual words therein), contents of information, context information associated with information, location information associated with information, links associated with information, meta data of information, and a caller group division of a subscriber terminal in a radio system.

The processing unit 104 can be configured in connection with the processing related to the associations also to carry out processing related to categories. The processing related to categories can be implemented for instance in such a manner that through the user interface 108 the user is offered different possibilities to function as regards the categories, for example the following possibilities: deleting a category, changing the properties of a category, creating a new category and associating information to the created category. The matters associated with the categories shown in the user interface 108 and the commands related to the categories obtained from the user interface 108 thus enable the user to delete an existing category, create a new category and change the properties of existing categories.

The processing unit 104 is configured to store the associations in the memory 112 for subsequent use.

Configuring the processing unit 104 forms structural entities, which can be implemented for instance as program modules, coded with a programming language, such as a C programming language, a C++ programming language, a machine language or an assembler that is stored as a runtime version into the memory in the processor and that is run by the processor. Instead of translatable programming languages, interpretable programming languages can naturally also be used, presuming that the use thereof meets the required processing rate and power. When implementing the processing unit 104 in ASIC form, the structural entities are ASIC blocks.

The processing unit 104 can be configured to perform processing and association in parallel or in turn. What “processing” refers to in this context is processing information simultaneously as it is presented in the user interface 108, and the user interface 108 is used to provide commands for processing information. In an embodiment the information is a file, and the processing unit 104 is configured to carry out association when opening, storing or closing the file. In another embodiment the information is a web site, and the processing unit 104 is configured to carry out association when browsing to the web site. Parallel computing refers to the fact that processing is carried out as a specific process or task and association as a specific process and task. Parallel processing requires a multi-tasking computer, which can be implemented using an operating system that allows multi-tasking. Such a solution is also possible, in which processing is carried out in turn, either so as to perform processing at first and association thereafter, or then so as to perform tasks in turn a particular time slice at a time. The latter way is one way to implement virtual parallelism.

In an embodiment the processing unit 104 is configured to remind the user in the user interface 108 about the association stored in the memory 112. The association associated with the information may thus help the user to remember a necessary matter. A simple example is such where the processing unit 104 is configured to determine the present instant of time and to carry out a reminder concerning the association associated with the determined instant of time stored in the memory 112. An association may for instance be associated with a particular date and/or time. The processing unit 104 can be configured to determine the state of the subscriber terminal in the radio system (for example a profile currently used in a mobile phone, or information about whether a call is in progress), and to send a reminder in the user interface 108 if it fits into the determined state. For instance, during an ongoing call, the reminder is probably not performed. On the other hand, the reminder can be carried out in the user interface 112 concerning the association associated with the determined state—stored in the memory 112. For example, a reminder associated with a particular profile can be carried out; for example, when the profile is a “meeting” the reminder may concern an e-mail message about the meeting.

Reminding based on a more complicated logic is also possible. In an embodiment the processing unit 104 is configured to sense the operational environment of the portable data processor and to perform the reminder in the user interface 108 concerning the association associated with the sensed operational environment stored in the memory 112. Sensing the operational environment of the data processor may take place in different ways. FIG. 1 describes a sensor 110 that senses the operational environment. The sensor 110 may for instance be a GPS receiver (Global Positioning System) or a receiver of another positioning system, which allows defining the location of the data processor. A separate sensor 110 is not necessarily required, since the subscriber terminal may be fairly accurately located in the current mobile systems on the basis of sent and/or received radio signals. The sensor 110 may also be very simple, for instance an electrical or electromechanical sensor indicating that the data processor is connected to a desk-top charger or to a car charger, for example.

In an embodiment the processing unit 104 is configured to determine the context information associated with the location of the subscriber terminal in the radio system and to carry out in the user interface 108 the reminder concerning the association associated with the determined location stored in the memory 112. This can be implemented for instance so that the terminal comprises a Bluetooth™ transceiver or another device implementing local connectivity that allows forming an ad hoc network. An integrated circuit according to the Bluetooth™ technology implements a radio connection having a coverage of a few hundred metres at the most, for instance at a frequency of 2.4 giga hertz. For example, when the terminal is close enough to a home communication centre communicating using Bluetooth™, it may be assumed that the location is home. Or, when one is close to a ticket machine, the user may be reminded about the fact that a ticket must be bought for the journey taking place the day after tomorrow.

Let us next take a closer look at the classification of a simple e-mail message described in FIG. 2 in a portable data processor. The e-mail programme to be run in the processing unit 104 of the data processor has received an e-mail message 200. The user interface 108 connected to the processing unit 104 enables to present said information to the user when the e-mail programme has received from the user interface 108 a command provided by the user to read the e-mail message. The e-mail message may already be stored in the memory 112 or it may be stored therein later. The processing unit 104 is configured to associate the e-mail message multi-dimensionally into at least two different categories according to information type and at least one other criterion. In an embodiment the processing unit 104 is configured to carry out association when opening the e-mail message for reading either by processing in parallel or in turn as shown above. In addition, the processing unit 104 is configured to present the associations in the user interface 108 and to carry out the processing related to the associations based on the commands obtained from the user interface 108, and to store the associations in the memory 112 for subsequent use. In an embodiment the processing unit 104 is configured to carry out the presentation when the e-mail message is being closed or when moving to the following e-mail message. If the user rejects all proposed associations, the e-mail message can be placed into an incoming e-mail message file, or it may be moved to the recycle bin.

A classification algorithm to be run in the processing unit 104 may search from the e-mail message, for instance, the following classification data: sender, date of arrival, priority. If the classification is based on searching key words from the text, then words like “summer holidays” and “proposal” can be found from the subject field in header data 202 of the e-mail message 200. Furthermore, character strings that resemble the general formats of dates can be retrieved from a text part 204 in the e-mail message 202.

Then the retrieved classification data are compared with the classification criteria. Basically connecting two elements, like classification data (such as John Doe) and classification criteria (such as a sender), together provides an association between the two. Thus, the classification proposal of the e-mail message 200 could for instance be the following:

type=e-mail message,

sender=John Doe,

received=15 May 2002,

priority=normal, and

subject=“summer holidays”, “proposal”, “31 May 2002”.

If the user accepts the proposed classification, the user's portable data processor may remind the user about this message, for instance one day before said date 31 May 2002.

The user may also add previously defined groupings to the classification. A grouping typically found in mobile phones in particular is a division based on caller groups. The example message presented herein could allegedly belong to the group “work”, since the message has arrived from the manager that belongs to the caller group “work”. However, the user may himself/herself control such a grouping, and therefore he/she may if desired add “home” as a grouping, so as to remember to agree upon his/her days off with his/her family while being at home. This creates the function already described above at the search function side: if the mobile phone is capable of sensing the operational environment thereof, then it is also capable of reminding about domestic matters at home and about business matters at work. In this example, the portable data processor might remind about the days off when it detects that the user is at home and the stipulated date 31 May 2002 stored is approaching. Naturally the apparatus does not have to be able to observe the changes in the environment, and the logic of the reminders may as well be based on time or other corresponding data as shown above.

An alternative classification for an e-mail message could be as follows, using a slightly different classification algorithm:

type=e-mail message,

sender=John Doe,

received=15 May 2002,

priority=normal,

stipulated date=31 May 2002 (selected by the user)

first group=work, and

second group=home (selected by the user).

What is important is to note that the classification may suggest an association, such as a stipulated date, and the addition of a previously defined group (i.e., for instance that the e-mail message belongs to both groups “work” and “home”).

Another extreme classification example is a classification carried out purely based on text type (in contrast to the structural classification described above), whereby all different keywords are of similar value, i.e. “John Doe”, “15 May 2002”, “summer holidays”, “proposal” and “31 May 2002”.

The classification itself, i.e. retrieving the classification criteria and classification data, can be carried out in accordance with the prior art. The classification algorithm may vary. For instance, technologies derived from a self-organizing map (SOM), which is a neuronetwork invented by the Finnish professor Teuvo Kohonen, can be applied to implement the classification algorithm. The SOM is described in publication Teuvo Kohonen: Self-organizing Maps, third extended edition 2001, ISBN 3-540-67921-9. The SOM or the extensions thereof, such as WEBSOM, have been used for example for classifying XML documents (Extensible Markup Language). However, what is concerned here regarding the classification, is an alternative to how the classification algorithm can be carried out. The technologies further derived from SOM are only a branch in an extensive algorithm tree. The use of WEBSOM is described in publication Honkela, T., Kaski, S., Lagus, K & Kohonen, T. (1996). Newsgroup Exploration with WEBSOM method and browsing. Technical Report A 32, Helsinki University of Technology, Laboratory of Computer and Information Science, Espoo, Finland.

For retrieving classification data, “keyword spofting” can for example be used, where the idea is to automatically find possibly predetermined and best describing key words from the text, or “text mining”, where words describing the text are retrieved, while common words such as “and” and “or” are left unnoticed. Also semantic networks can be utilized. The use of semantic networks allows classifying information. The classification data is preliminary stored in the material, for instance on the web sites of a World-Wide Web (WWW) server. The principle of a semantic network can be utilized for retrieving various key data from the material, since metadata is added to the information in a semantic network that informs the reader for example about the nature of the information. The classification algorithm may thus find classification criteria in accordance with the principles of a semantic network.

Several different, also multi-dimensional, automatically functioning classifiers can be used to implement a classification algorithm: however, in this semi-automatic way, the user may affect the classification himself/herself, in which case the final result is useful and the described classification can be used for more heterogeneous data than typical automatic classifiers. No sides are taken regarding the classification algorithm, and the algorithm may for instance be self-learning, although a user is typically himself/herself capable of perceiving interdependencies more effectively than a mere automatic algorithm.

In the following, with reference to the block diagram in FIG. 3, a method is described for classifying information in a portable data processor. The process starts in 300. Then in 302, information is processed on the basis of commands obtained from the user interfaces of a portable data processor. It is presumed that the information to be processed is stored in a data store 314, from which the data can be retrieved for processing 302. The information in the data store may be of different types, such as: a file, an e-mail message, a web site, a text message, a multi-media message, a calendar message, a task message, another set of data presented using alphabetic and/or numeric characters, or binary data. When the information is a file, association 312 can be carried out when opening, storing or closing the file, and a presentation 306 can be carried out when storing or closing the file. When the information is an e-mail message, the association 312 can be carried out when opening the e-mail message for reading, and the presentation 306 can be carried out when closing the e-mail message or when moving to the following e-mail message. When the information is a web site, the association 312 can be carried out when browsing at the web site, and the presentation 306 can be carried out when exiting the web site, or when closing the browser used for browsing, or later on when the process is offline.

Then in 312 the information is multi-dimensionally associated into at least two different categories according to information type and at least one other criterion. The criteria comprise at least one of the following: title of information, contents of information, context information associated with information, location information associated with information, links associated with information, meta data of information, caller group division of subscriber terminals in a radio system.

In this example, information processing is continued in 304. Such a division of information processing into 302 and 304 mainly describes how processing in 302 and 304 as well as association in 312 can be carried out in parallel or in turn as is shown in FIG. 3. Processing can also be carried out in various stages, for instance an e-mail message can be opened in 302 and in 304 the process moves to the following e-mail message.

Then in 306, the associations are presented in the user interface and in 308 the processing related to the associations is carried out based on the commands obtained from the user interface. In an embodiment the processing related to the associations comprises at least one of the following: accepting an association, rejecting an association, changing an association. In an embodiment, in connection with the processing related to the associations, processing related to categories is also carried out, for instance in such a manner that the processing related to categories comprises at least one of the following: deleting a category, changing the properties of a category, creating a new category and associating information into the created category.

Finally in 310, the associations are stored for subsequent use in the data store 316. The method ends in 318. Even though the data stores 314 and 316 are described as separate reserves, they are able to be combined in certain conditions.

In an embodiment, the method further comprises: a portable data processor reminds the user in the user interface about the stored association. This can be implemented in various ways. For example in such a manner that the method also comprises: a portable data processor senses the operational environment thereof and carries out the reminder in the user interface concerning the stored association associated with the operational environment thereof. Or, in such a manner that the method further comprises: a portable data processor determines the present instant of time and for carrying out a reminder in the user interface concerning the stored association associated with the determined instant of time. The portable data processor may determine the state of the subscriber terminal in the radio system, and send the reminder in the user interface, if it suits the determined state. The portable data processor may also carry out the reminder in the user interface concerning the stored association associated with the determined state. The portable data processor may determine the context information associated with the location of the subscriber terminal in the radio system, and carry out a reminder in the user interface concerning the stored association associated with the determined location.

A portable data processor as described above is applicable to carry out the method, but other kinds of apparatuses can also be employed for carrying out the method, in which information is processed and which comprise a user interface and utilize as described the classification of the information.

Even though the invention has above been explained with reference to the example in the accompanying drawings, it is obvious that the invention is not restricted thereto but can be modified in various ways within the scope of the inventive idea disclosed in the attached claims.

1. A method for classifying information in a portable data processor, comprising:
processing information based on commands obtained from a user interface in the portable data processor;
associating information multi-dimensionally into at least two different categories according to information type and at least one other criterion;
presenting the associations in the user interface and carrying out processing related to the associations based on the commands obtained from the user interface; and
storing the associations for subsequent use.

2. A method as claimed in claim 1, wherein processing and association are carried out in parallel or in turn.

3. A method as claimed in claim 1, wherein the processing related to the associations comprises at least one of the following: accepting an association, rejecting an association, changing an association.

4. A method as claimed in claim 1, wherein in connection with the processing related to associations, processing related to categories is also carried out.

5. A method as claimed in claim 4, wherein the processing related to categories comprises at least one of the following: deleting a category, changing the properties of a category, creating a new category and associating information into the created category.

6. A method as claimed in claim 1, wherein the criteria comprise at least one of the following: title of information, contents of information, context information associated with information, location information associated with information, links associated with information, meta data of information, caller group division of a subscriber terminal in a radio system.

7. A method as claimed in claim 1, wherein the information comprises at least one of the following: a file, an e-mail message, a web site, a text message, a multimedia message, calendar data, task data, a data group presented using alphabetic and/or numeric characters signs, or binary data.

8. A method as claimed in claim 1, wherein the method further comprises:
the portable data processor reminds the user in the user interface about the stored association.

9. A method as claimed in claim 8, wherein the method further comprises:
the portable data processor determines the state of a subscriber terminal in a radio system, and carries out a reminder in the user interface if it suits the determined state.

10. A method as claimed in claim 1, wherein the method further comprises:
the portable data processor senses the operational environment thereof and carries out a reminder in the user interface concerning the stored association associated with the sensed operational environment.

11. A method as claimed in claim 1, wherein the method further comprises:
the portable data processor determines the current instant of time, and carries out a reminder in the user interface concerning the stored association associated with the determined instant of time.

12. A method as claimed in claim 1, wherein the method further comprises:
the portable data processor determines the context information associated with the location of the subscriber terminal in the radio system, and carries out the reminder in the user interface concerning the stored association associated with the determined location.

13. A method as claimed in claim 1, wherein the method further comprises:
the portable data processor determines the state of the subscriber terminal in the radio system, and carries out the reminder in the user interface concerning the stored association associated with the determined state.

14. A method as claimed in claim 1, wherein the information is a file, and the association is carried out when opening, storing or closing the file.

15. A method as claimed in claim 1, wherein the information is a file, and the presentation is carried out when storing or closing the file.

16. A method as claimed in claim 1, wherein the information is an e-mail message, and the association is carried out when opening the e-mail message for reading.

17. A method as claimed in claim 1, wherein the information is an e-mail message, and the presentation is carried out when closing the e-mail message or when moving to the following e-mail message.

18. A method as claimed in claim 1, wherein the information is a web site, and the association is carried out when browsing on the web site.

19. A method as claimed in claim 1, wherein the information is a web site, and the presentation is carried out when exiting the web site, or when closing the browser used for browsing the web site, or later when the process is offline.

20. A portable data processor, comprising:
a processing unit for processing information,
a user interface connected to the processing unit for presenting the information to a user of the portable data processor and for providing commands in order to process information, and a memory connected to the processing unit for storing information,
and the processing unit is configured to:
associate information multi-dimensionally into at least two different categories according to information type and at least one other criterion,
present the associations in the user interface and carry out the processing related to the associations based on the commands obtained from the user interface, and
store the associations in the memory for subsequent use.

21. Portable data processor as claimed in claim 20, wherein the processing unit is configured to carry out processing and association in parallel or in turn.

22. Portable data processor as claimed in claim 20, wherein the processing related to associations comprises at least one of the following: accepting an association, rejecting an association, changing an association.

23. Portable data processor as claimed in claim 20, wherein the processing unit is configured in connection with the processing related to associations also to carry out processing related to categories.

24. Portable data processor as claimed in claim 23, wherein the processing related to categories comprises at least one of the following: deleting a category, changing the properties of a category, creating a new category and associating information into the created category.

25. Portable data processor as claimed in claim 20, wherein the criteria comprises at least one of the following: title of information, contents of information, context information associated with information, location information associated with information, links associated with information, meta data of information, caller group division of a subscriber terminal in a radio system.

26. Portable data processor as claimed in claim 20, wherein the information comprises at least one of the following: a file, an e-mail message, a web site, a multi-media message, calendar data, task data, another set of data presented using alphabetic and/or numeric characters, or binary data.

27. Portable data processor as claimed in claim 20, wherein the processing unit is configured to remind the user in the user interface about the association stored in the memory.

28. Portable data processor as claimed in claim 27, wherein the processing unit is configured to determine the state of the subscriber terminal in the radio system, and to perform the reminder in the user interface, if it suits the determined state.

29. Portable data processor as claimed in claim 20, wherein the processing unit is configured to sense the operational environment of the data processor, and to perform the reminder in the user interface concerning the association stored in the memory associated with the sensed operational environment.

30. Portable data processor as claimed in claim 20, wherein the processing unit is configured to determine the present instant of time and to perform the reminder in the user interface concerning the association stored in the memory associated with the determined instant of time.

31. Portable data processor as claimed in claim 20, wherein the processing unit is configured to determine the context information associated with the location of the subscriber terminal, and to perform the reminder in the user interface concerning the association stored in the memory associated with the determined location.

32. Portable data processor as claimed in claim 20, wherein the processing unit is configured to determine the state of the subscriber terminal in the radio system, and to perform the reminder in the user interface concerning the association stored in the memory associated with the determined state.

33. Portable data processor as claimed in claim 20, wherein the information is a file and the processing unit is configured to carry out the association when opening, storing or closing the file.

34. Portable data processor as claimed in claim 20, wherein the information is a file and the processing unit is configured to carry out the presentation when storing or closing the file.

35. Portable data processor as claimed in claim 20, wherein the information is an e-mail message and the processing unit is configured to carry out the association when opening the e-mail message for reading.

36. Portable data processor as claimed in claim 20, wherein the information is an e-mail message and the processing unit is configured to carry out the presentation when closing the e-mail message or when moving to the following e-mail message.

37. Portable data processor as claimed in claim 20, wherein the information is a web site and the processing unit is configured to carry out the association when browsing on a web site.

38. Portable data processor as claimed in claim 20, wherein the information is a web site and the processing unit is configured to carry out the presentation when exiting the web site or when closing the browser used for browsing or later when the data transmission connection of the portable data processor is offline.
